(19) United States
(12) Patent Application Publication
(10) Pub. No.: US 2009/0287610 A1
(43) Pub. Date: Nov. 19, 2009

(54) Data Processing

(75) Inventors: Jonathan Marsden Bradshaw, Surbiton (GB); Matthew Charles Forrester, New Waltham (GB)

Correspondence Address: RICHARD M. GOLDBERG, 25 EAST SALEM STREET, SUITE 419, HACKENSACK, NJ, 07601, US

(73) Assignee: MEDIAEQUALS LIMITED, London (GB)

(21) Appl. No.: 12/464,439

(22) Filed: May 12, 2009

(30) Foreign Application Priority Data
May 13, 2008 (GB) 08 08 653.0
May 14, 2008 (GB) 08 08 743.9

(51) Int. Cl. G06Q 30/00

(52) U.S. Cl. 705/80; 705/27

(57) ABSTRACT

A data processing procedure is shown in which the processed data includes data representing negotiations for the purchasing of a package of inventory, taking the form of offers and counter offers between a single major party and a plurality of minor parties, and data stored in a database representing details of the items of inventory available for sale. The procedure identifies a package of inventory from the database and presents a major graphical user interface to a major party that shows data from each of a plurality of participating minor parties. Minor graphical interfaces are presented to each of the minor parties that show a first indication of time remaining (601) a second indication of the proportion of the package of inventory remaining (602) and a representation (603, 604, 605) of each participating minor party. The representation of each minor party includes an indication (608) as to whether the respective minor party has made an offer and an indication (609) as to whether the respective minor party has made an offer that has been accepted.

### CROSS REFERENCE TO RELATED APPLICATIONS

This application claims priority from United Kingdom Patent Application No. 08 08 653.0, filed May 13, 2008 and United Kingdom patent application No. 08 08 743.9 filed May 14, 2008, the whole contents of which are incorporated herein by reference in their entirety.

### BACKGROUND OF THE INVENTION

1. Field of the Invention

The present invention relates to a method of data processing for the purchasing of inventory and in particular for the purchasing of advertising media. In a first embodiment, negotiations take place between individual parties. In an alternative embodiment, negotiations take place between a plurality of parties. In a third embodiment, provision is made for the granting of options.

2. Description of the Related Art

Technical solutions for the buying and selling of items are known and include many well known website brands. Systems for the selling of many items from an inventory stored on a database are also known and have been used for many years in the airline industry for example.

The electronic sale of media items, such as advertisements in newspapers, radio commercials and billboard displays has proved problematic given the sophisticated nature of negotiations that occur within this environment. Methods of auctioning media inventory are described in U.S. patent application Ser. No. 11/843,022 filed Aug. 22, 2007 and assigned to the preset assignee. A particular type of upgrade auction is also described in U.S. patent application Ser. No. 11/843,116, assigned to the present assignee in which multiple instances of substantially similar items may be auctioned in which a plurality of bidders are successful.

Having been presented with problems associated with the selling of media advertising opportunities, the applicant has also realised that the solutions forming the basis for the present application also have wider application. This includes the sale of exhibition space for example. The specific application described herein should not therefore be seen limiting over the wider application of the invention as claimed.

In practice, the buyers of advertising media are often agencies and over time, sophisticated relationships have become established between individuals working in agencies and individuals selling media items. It is known for the price of media items to be identified in a rate card and much of the negotiation between buyers and sellers, presently done over the telephone, involves obtaining discounts from the established rate card price.

Thus, it has been appreciated that the present processes for negotiating the sale of media inventory is relatively inefficient and could benefit from an introduction of technology. However, problems exist in terms of creating technical solutions that provide a more efficient environment while at the same time not alienating existing buyers and sellers, which would in turn lead to the non-adoption of the techniques.

### BRIEF SUMMARY OF THE INVENTION

According to a first aspect of the present invention, there is provided a method of data processing, wherein processed data includes: data representing negotiations for the purchasing of a package of inventory, taking the form of offers and counter-offers between a single major party (buyer or seller) and a plurality of minor parties (sellers or buyers); and data stored in a database representing details of the items of inventory available for sale. The method comprises the steps of identifying a package of inventory from the database; presenting a major graphical user interface to a major party that shows data from each of the plurality of participating minor parties; and presenting a minor graphical user interface to each of said minor parties. Each minor graphical user interface shows a first indication of time remaining; a second indication of the proportion of the package of inventory remaining; and a representation of each participating minor party. Furthermore, each representation of the other participating minor parties includes an indication as to whether the respective minor party has made an offer; and an indication as to whether said respective minor party has made an offer that as been accepted.

In a preferred embodiment, the inventory is an advertising media inventory.

According to a second aspect of the present invention, there is provided a method of data processing in which the data represents negotiations for the purchasing of an item or items of time critical inventory. The method comprises the steps of storing data relating to details of a time critical inventory of items that have a sale price and an execution date in a database, receiving first information from a buyer identifying an item of interest from the inventory and sending said first information to a seller. A second information is received from the seller identifying the price and an execution date for the item of interest. The second information is sent to the buyer and a third information is received from the buyer that defines an option request that specifies an option period during which the item of interest could not be sold to another buyer. The third information is sent to the seller and fourth information is received from the seller stating that the option has been accepted, rejected or that the option period is to long and the fourth information is sent to the buyer.

In a preferred embodiment, a history is maintained of previous option transactions for each of a plurality of buyers and the take-up rate is calculated for each of the buyers. An indication of a buyers take-up rate may be sent to a seller.

According to a third aspect of the present invention, there is provided a method of data processing in which said data represents negotiations for purchasing an item or items of inventory. Data is stored relating to an inventory of items at a server and information is received from a buyer and a seller identifying an item or items from the inventory for which the buyer and the seller purpose to enter into a negotiation. Data is supplied to the buyer to establish a buyer graphical user interface and data is supplied to the seller to establish a seller graphical user interface. The buyer graphical user interface and the seller graphical user interface each display a local element representing the local party (buyer/seller), a remote element representing the remote party (seller/buyer), an indication of numerical offers made by the local party and the remote party and a graphical element showing the transmission of data between the buyer and the seller via the server so as to indicate an onus to respond.

### BRIEF DESCRIPTION OF THE SEVERAL VIEWS OF THE DRAWINGS

FIG. 1 shows an environment for data processing in which user terminals communicate with a server;

FIG. 2 shows an example of the database identified in FIG. 1;

FIG. 3 identifies procedures performed by the server identified in FIG. 1;

FIG. 4 illustrates operations performed within the environment of FIG. 1;

FIG. 5 illustrates a protocol diagram for the procedures detailed in FIG. 4;

FIG. 6 illustrates a major graphical user interface;

FIG. 7 illustrates a minor graphical user interface;

FIG. 8 illustrates an alternative embodiment for the establishment of options;

FIG. 9 shows a protocol diagram for the alternative embodiment identified in FIG. 8

FIG. 10 shows graphical user interfaces displayed to a buyer and a seller;

FIG. 11 shows a plurality of interfaces of the type shown in FIG. 10 displayed together;

FIG. 12 illustrates procedures for implementing the embodiment of FIG. 11;

FIG. 13 details procedures for media selection;

FIG. 14 details procedures for item selection;

FIG. 15 shows modifications to the second embodiment for defining options;

FIG. 16 shows an alternative configuration for the third embodiment showing the nesting of interfaces.

### DETAILED DESCRIPTION OF THE PREFERRED EMBODIMENTS

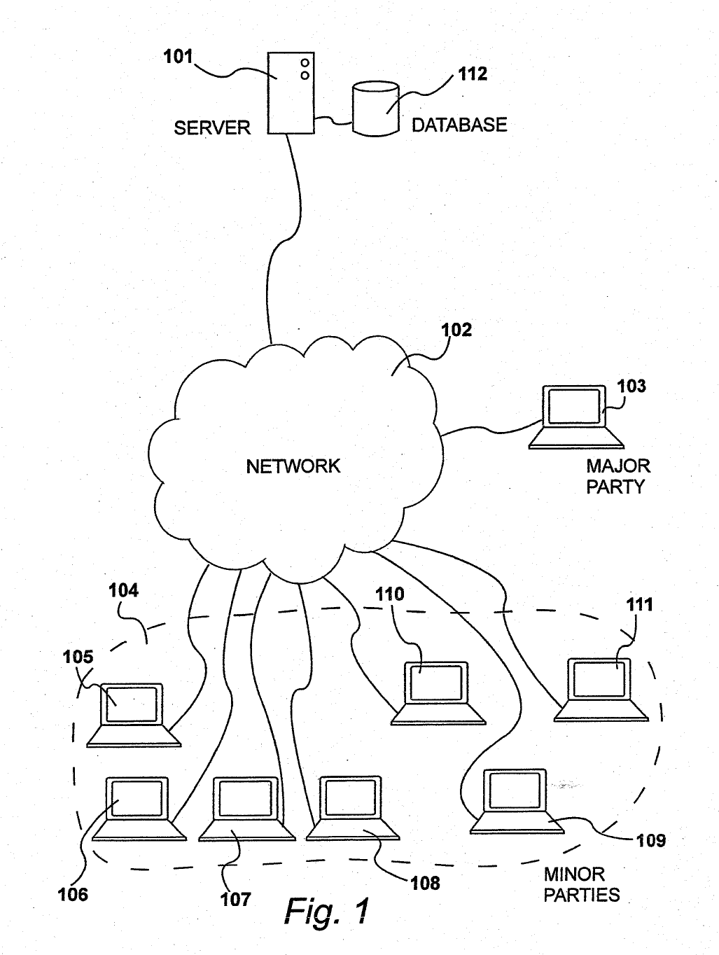

### FIG. 1

An environment for data processing is illustrated in FIG. 1 in which user terminals communicate with a server 101 via a network 102, such as the Internet. The environment has been configured to facilitate the processing of data in which said data represents negotiations for the purchasing of a packages of inventory, taking the form of offers and counter offers between a single major party 103 and the plurality of minor parties 104. In this example, minor parties 105 to 111 are shown although the invention could be deployed with substantially more minor parties. It is also appreciated that a subset of these minor parties may be involved in any particular negotiation.

The data processing activities also involve the processing of data stored in a database 112 that represents details of the items of inventory available for sale.

The invention is particularly attractive although, not exclusively, for the sale of advertising media. Under these circumstances, the major party could be a seller of advertising media and a particular package of available media could be identified to a plurality of potential buyers, constituting the minor parties.

In an alternative and preferred approach, the major party may be a buyer of advertising media and said buyer may have specified a particular package of preferred media, possibly in combination with a maximum budget. The minor players would then be made up of media sellers and it would be for these sellers to make contributions to the package until the whole of the package requirement has been satisfied. In particular, under these circumstances, the invention is aimed at providing competition between the minor parties, wherein each minor party is made aware of the existence of the other minor parties in a negotiation and is also informed as to whether offers have been made and/or accepted. Thus, it is possible for a minor party to see other minor parties making progress in terms of satisfying the package requirements, thus motivating them to make contributions themselves. Consequently, this technical environment to the problem of negotiating deals of this type is facilitated and it is the experience of the inventors that such an environment greatly reduces the amount of time taken for deals of this type to be concluded. Consequently, substantial savings may be made and/or additional parties may be brought into complex media deployment exercises

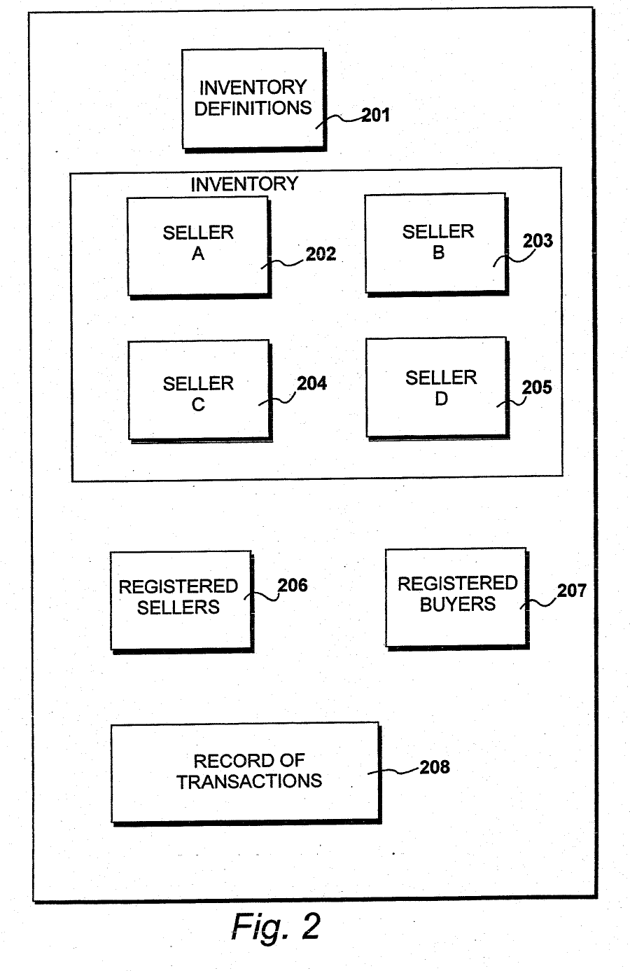

### FIG. 2

An example of database 112 is illustrated in FIG. 2, possibly being of a relational type including a plurality of tables. In the example of FIG. 2, table 201 includes inventory definitions. In a preferred embodiment, for the sale of advertising media, each type of advertisement is identified by tags thereby representing the advertisement type. Thus, these tags may specify that the advertisement is to be of a particular size, of a particular color and on a particular page of a newspaper or magazine for example. In this way, it is possible to briefly identify a particular advertisement type and make meaningful comparisons between different publications.

Tables 202 to 205 represent specific items of inventory available from respective sellers A to D. Thus, each specific example of a media item, of the type known to the inventory definitions table 201, is specified for each individual seller. Thus, in a preferred environment, the totality of available advertising space is closed and each specific inventory item may be sold only once. However, alternative configurations are possible in which a degree of flexibility may be introduced. Thus, the number of items shown as being available at any one time may be restricted, and the actual maximum number of items available may include a degree of flexibility, on the basis that it would be possible to publish additional pages for example. However, from a transactional prospective, it may be preferable to assume that the total number of available advertising opportunities is fixed.

A table 206 maintains details of registered sellers and a similar table 207 maintains a list of registered buyers. The table 208 maintains a record of transactions, thereby ensuring that the operations create a detailed audit trail.

Preferably the data and the functionality of the procedures are maintained at the server 101 along with the database 112, with devices for the minor parties and the major party being substantially conventional. Thus, the system illustrated in FIG. 1 may operate with terminals 103 to 111 deploying conventional browser software each configured to receive HTML web pages from server 101.

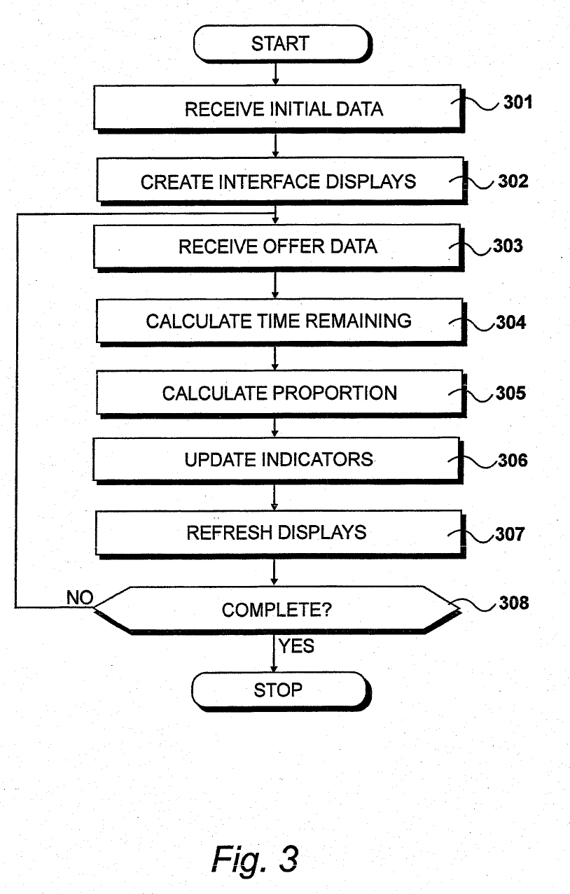

### FIG. 3

Procedures performed by server 101 are detailed in FIG. 3. At step 301 initial data is received taking the form of an identification of a particular package of inventory defined within database 112. Thus, this is likely to be made up of inventory definitions in table 201 of a nature that could be satisfied by many of the sellers.

At step 302 interface displays are created taking the form of a major graphical user interface which is presented to a major party that shows data from each of a plurality of participating minor parties. Similarly, minor graphical user interfaces are created at step 302 which are in turn conveyed to each of the minor parties.

A preferred embodiment is designed to encourage deals to be concluded rapidly therefore for each negotiation a time limit is identified which, for example, may have a default range of between 30 minutes and 3 hours for example. Consequently, graphical user interfaces supplied to each of the minor parties include an indication of time remaining along with an indication of the proportion of the package of inventory remaining. The minor interfaces also show a representation of each participating minor party and each of these representations includes an indication as to whether the respective minor party as made an offer or an indication as to whether the respective minor party has made an offer that as been accepted.

Thus, at step 303 offer data is received and at step 304 a calculation is made as to the time remaining. Similarly, at step 305 a calculation is made as to the proportion of the package remaining, whereafter at step 306 indicators are updated and displays are refreshed at step 307.

At step 308 a question is asked whether the transaction is complete. The transaction will have been completed if all items within the package have been provided or if a timeout condition has occurred. Thus, when answered in the negative, to the effect that the transaction is not complete, further data is received at step 303. However, eventually the transaction will have been completed resulting in the question asked at step 308 being answered in the affirmative and the process completing.

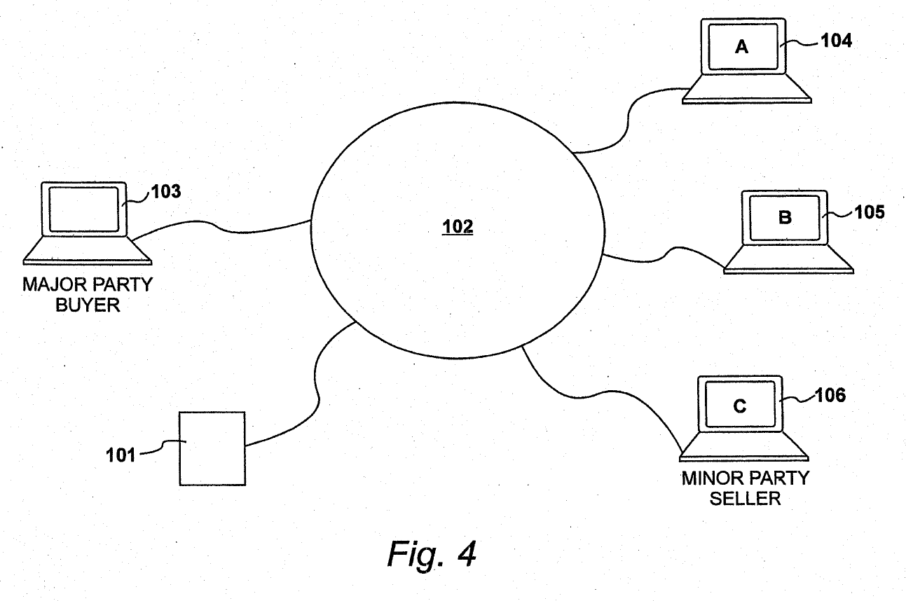

### FIG. 4

For the purposes of illustration, it will be assumed that the inventory consists of advertising media, that may in turn include newspaper advertisements, magazine advertisements, posters, billboards, television commercials and radio commercials.

Many auction techniques are known in which a single seller receives bids from a plurality of potential buyers. The present embodiment may be deployed in a similar environment, in which the seller is the major party and the minor parties represent potential buyers. However, the embodiment is particularly attractive in an alternative arrangement in which the major party is a buyer and the minor parties are potential sellers. Thus, for example, major party 103 may be a buyer of media and this buyer may have identified a particular package (as part of an advertising campaign) along with a maximum budget that they are prepared to spend in order to satisfy this package. A plurality of media sellers are known that could completely satisfy the package or partially satisfy the package, such that for example the package could be completely satisfied if two or more sellers co-operate. Thus, for the purposes of this example, it is assumed that buyer 103 has put together a package for media with a particular budget. Communications have been sent out to all of the minor parties 104 to 111 and minor parties 104 to 106 have expressed an interest in terms of putting forward proposals that form part of the package. Thus, in this example, entities 104 to 106 become minor party sellers.

The minor party sellers 104 to 106 are looking to make sales and to obtain maximum yield from each of these sales. When selling advertising media, it is known that each particular media item within a particular publication or similar medium as an accepted standard charge often defined by an entry on a rate card. Often negotiations take the form of proposals for percentage discounts off the rate card price. Thus, at the rate card value, the yield may be considered as being 100% and a discount of 20% off rate card represents a yield of 80%. Thus, a seller wishes to put forward proposals that are as close to the rate card value as possible, thereby obtaining maximum yield. Under exceptional circumstances, when special events occur for example, it may even be possible to obtain a yield above the rate card value but it is anticipated that the majority of negotiations will take place in relation to fractional yields.

From the buyers prospective, it is desirable to satisfy the requirements of the package while minimising total spend and thereby making savings and incurring a total charge that is below budget. This will allow clients to make financial savings or alternatively it would allow agencies to make additional advertising deployments.

The major party buyer in this example, identifies a package of media and is looking for the best terms from the minor party sellers 104 to 106. Thus, while seeking to complete the requirements of the package quickly, the major party buyer is also looking to obtaining maximum discounts.

Within the technical environment provided by the preferred embodiment, the above is achieved by generating a degree of competition between the minor party sellers. Similarly, preferred aspects of the invention are directed towards emphasising this competitive environment, such that minor party sellers that have not made sales are made aware of the situation and in particular are made aware of more successful minor party sellers, in terms of those who have put forward an offer and those who have been successful in terms of their offer being accepted.

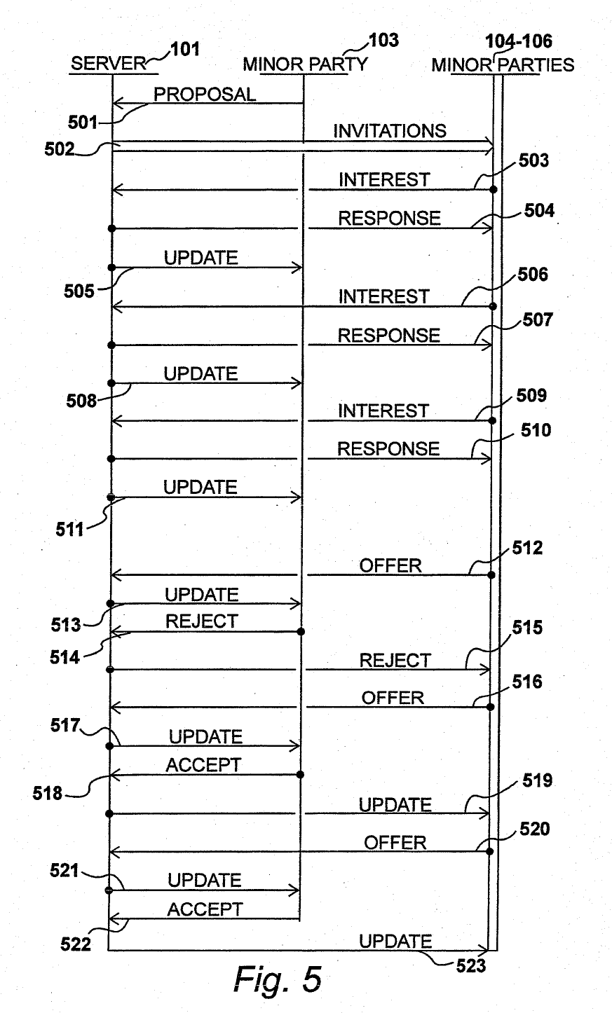

### FIG. 5

A protocol diagram is illustrated in FIG. 5 showing an example of an interaction that may occur within the environment of FIG. 4. The example of FIG. 5 represents a relatively straightforward interaction in which the major party buyer is looking to reach closure quickly and will therefore accept offers based on a predefined acceptance level.

As previously described, server 101 communicates with the major party buyer 103 and the minor party sellers 104 to 106.

At 501 a major party buyer 103 identifies a proposal in terms of a media package, a budget and possibly a time period over which agreement is to be reached. This proposal is conveyed to server 101 which at 502 issues invitations to all minor parties 104 to 106 and (at this stage) 107 to 111.

At 503 minor party 104 expresses an interest resulting in a response being received at 504. This response consists of sending a minor party graphical user interface. Similarly, at 505 the major graphical user interface displayed to major party buyer 103 is updated, confirming that minor party 104 has expressed an interest.

At 506 minor party 105 expresses an interest resulting in a response being received at 507 from the server 101m and again an update at 508 is provided to the major graphical user interface. In addition, this update will also update the user interface at 104, such that both minor parties 104 and 105 will see an indication of themselves and an indication of the other party.

Similarly, at 509 minor party 106 expresses an interest resulting in a response 510 showing a minor party graphical user interface with minor party 106 and the competing parties 104 and 105. Again, the other interfaces are updated at 511 such that each interface (the major and the three minor) all show the presence of three interested minor party sellers.

At 512 minor party 104 makes an offer resulting in updates being generated at 513. This informs the major party buyer that an offer has been made and also informs the other minor party sellers to the effect that an offer has been made. This update primarily encourages the other minor party sellers to make offers themselves, otherwise they run the risk of being left out of the package proposal.

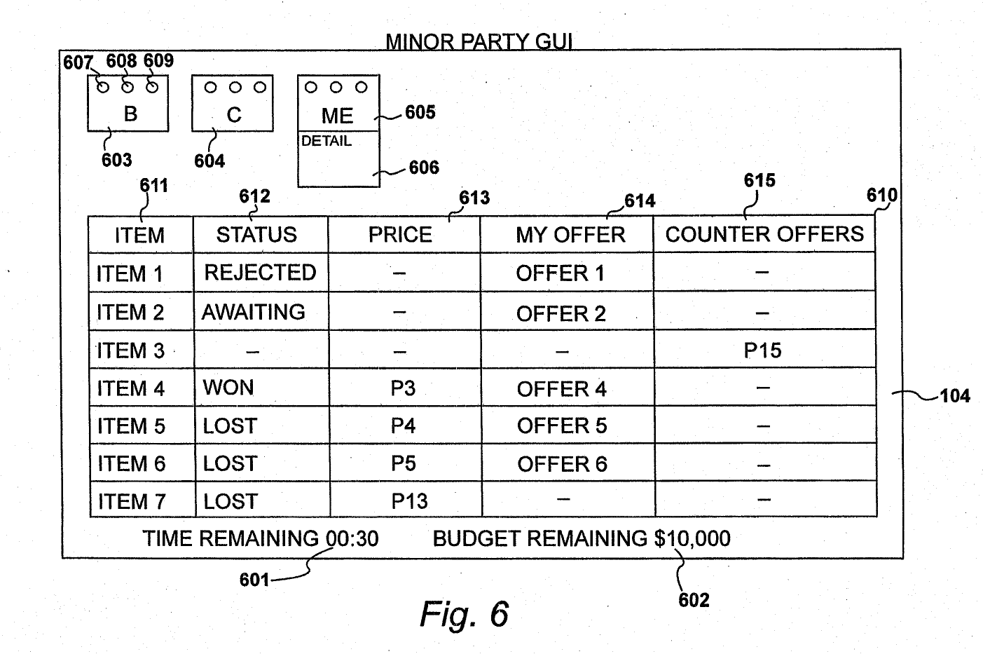

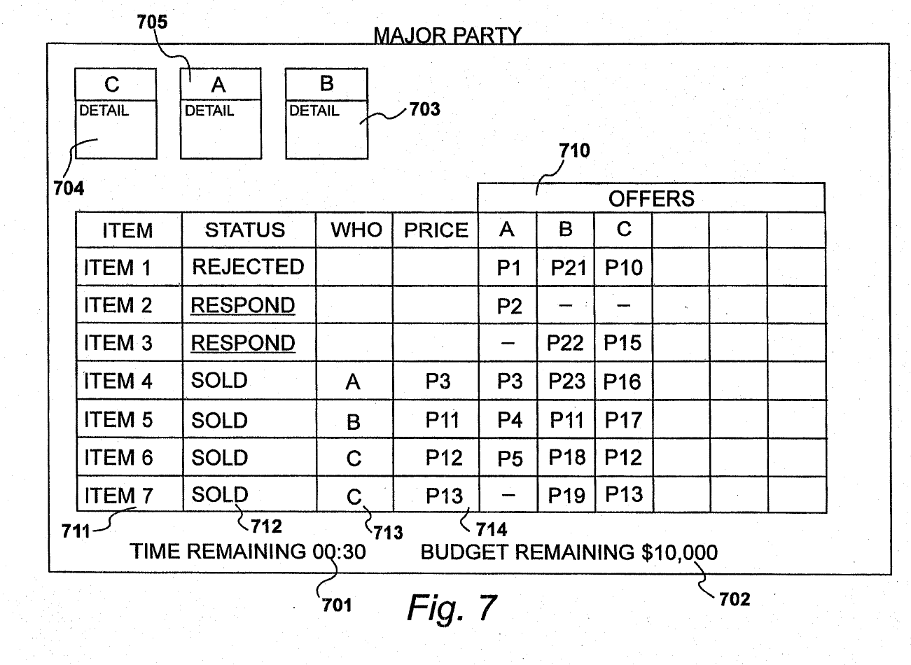

The major party buyer is required to either accept or reject the offer that has been made. In the present embodiment, this decision is made immediately when offers are received. However, in an alternative embodiment, as described with reference to FIG. 6 and 7, it is possible for several offers to be received and for responses to be provided later after the offers have been compared.

Thus, in this example, the major party buyer decides to reject the offer as conveyed to the server at 514 and the rejection is then relayed back to minor party 104 at 515. Thus, at this point, the major party seller knows that the offer has been rejected. However, the other minor party sellers 104 to 106 are only aware of an offer being made. They are not aware that the offer has been rejected although they will receive further information if an offer is actually accepted.

At 516 minor party seller 105 makes an offer resulting in an update to the graphical user interfaces occurring at 517. On this occasion, the major party 103 decides to accept the offer and this acceptance is conveyed to the server at 518. Consequently, an update occurs to all graphical user interfaces at 519 to the effect that an offer has been made and that this offer has been accepted. However, for the purposes of this illustration, it is assumed that the offer does not complete the overall package and further items within the package remain available.

At 520 a further offer is made for the remaining items from minor party seller 106. The server 101 updates the major party graphical user interface at 521 and the acceptance is confirmed at 522. This effectively completes the transaction because all of the items have been satisfied therefore a final update to all user interfaces occurs at 523.

### FIG. 6

A preferred aspect of the present invention involves presenting a major graphical user interface to a major party, an example of which is shown in FIG. 7 and presenting a minor graphical user interface to each of the minor parties, an example of which is shown in FIG. 6.

An example of a minor graphical user interface is shown in FIG. 6 and includes a first indication 601 of the time remaining during which offers may be made. This is seen as a mechanism for placing pressure on the minor parties to submit offers in a timely fashion, otherwise they will lose out.

The minor party interface also includes a second indication 602 of the proportion (preferably in monetary terms) of the package of inventory that remains available; that is to say, for which no offers have accepted. Again, this is intended to place pressure on the minor parties such that having missed a proportion of the package, the unsuccessful parties will be more inclined to make an offer for what remains.

In terms of the negotiations coming to a close, closure will take place at the end of the allocated time period, that is to say when no further time remains or when offers have been accepted for all of the items in the package.

The minor party interface includes a representation 603, 604, 605 for each respective participating minor party, including the local minor party.

In this example, for the purposes of illustration only, it has been assumed that three minor party sellers 104, 105 and 106 are in negotiation with a major party buyer 103. The minor party sellers 104 to 106 are also identified as A, B and C respectively and the graphical user interface of FIG. 6 is presented to minor party seller A via terminal 104.

The local party (party A) is identified by representation 605 where the name of the party is identified as “me” and full details of the minor party are included in region 606, thereby allowing the minor party to check that these details are correct.

The competing minor parties are represented at 603 and 604 but their full details are not shown. Consequently, the local party A is aware that competitors exist but the local minor party does not know the name of these competitors and is not provided with any further details. The full details of each minor party are made available and are known to the major party, as illustrated in FIG. 7.

Within each representation 603 to 605 of a minor party there is provided an indication as to whether the respective minor party has made an offer and an indication as to whether the minor party has made an offer that has been accepted. In a preferred embodiment, the representation of each minor party also includes an indication to the effect that the minor party has not made an offer.

It can be appreciated that in the art of graphical user interfaces, many techniques may be deployed for effecting these indications relating to the status of a minor party; namely that the minor party has not made an offer, that the minor party has made an offer (which may have been rejected or may be awaiting a response) or that the minor party has made an offer that has been accepted. The purpose of these indications is to emphasise to non-participating parties that other parties are making offers and that offers are being accepted, thereby putting pressure on the non-participating minor parties to submit offers.

In the example of FIG. 6, each representation includes three regions that may be illuminated, shown as region 607, region 608 and region 609. Region 607 may be illuminated in a first colour (say green), with region 608 being illuminated in a second colour (say amber) and the third region 609 being illuminated in a third colour (say red). In this example, only one region is illuminated at any instant such that a particular indication may be considered as being in a green state, an amber state or a red state. Again, in this particular implementation, the green state indicates that the minor party has not made an offer, the amber state indicates that the minor party has made an offer that has not been accepted and the red state is an indication to the effect that a minor party has made an offer and that offer has been accepted.

The minor party interface includes a package table 610 having an item column 611, a status column 612, a price column 613, a local offer column 614 and a counter offer column 615.

In the item column 611 the items making up the package are identified. In this example, they are shown as item 1 to item 7, each having a respective row in the package table 610. Column 612 identifies the current status of the negotiation in relation to the local minor party. Column 613 identifies the price of an item when the item has been sold. Column 614 identifies the local offer made by the local minor party and column 615 identifies appropriate counter offers.

In the example shown, by way of example only, item 4, item 5, item 6 and item 7 have been sold. These have been sold for prices P3, P4, P5 and P13 respectively as shown in the price column 613. The local minor party (represented by indicator 605) as successfully satisfied the requirement for item 4 therefore this item is identified by the status “1”. The local party did not make a successful sale for item 5, item 6 and item 7 therefore these are identified by the status “lost”.

The local minor party has made an offer to supply item 1 but currently this offer has been rejected and no other offer has been submitted. The local minor party has also made an offer to supply item 2 and is currently awaiting a response. No counter offers have been made. An offer has been made for item 3 by another of the minor parties but currently this offer has not been accepted.

At this point in time, all indications within the representations would be showing the red status on the basis that all three minor parties have made offers that have been accepted. In addition, the representations 603, 604 and 605 have been ranked from left to right. Thus, in this example, minor party B is shown as having the highest ranking with the local minor party being shown as having the lowest ranking. This ranking could be obtained based on the first minor party who successfully as an offer accepted. Alternatively, the ranking could be achieved based on an accumulation of deals of the highest value. The purpose of the ranking is to emphasis to minor parties that are lower in the ranking that they are competing unsuccessfully with minor parties higher in the ranking, thereby encouraging them to make more attractive offers.

### FIG. 7

An example of a major graphical user interface is shown in FIG. 7 and again includes a first indication 701 of the time remaining during which offers may be made along with a second indication 702 of the proportion in monetary terms of the package of inventory that remains available.

The major party interface includes a representation 703 for minor party B, and representation 704 for minor party C and representation 705 for minor party A. The full details of all minor parties are shown. It should also be appreciated that the ranking of the minor parties differs in the major party interface compared to the minor party interfaces. This is because, in the preferred embodiment, the ranking is derived from different criteria. Thus, the ranking may be derived from a plurality of sales, including sales achieved over several unrelated transactions. Thus, although minor party B could be successfully closing the highest value deals in this particular instance, overall it may have been calculated that minor party C may provide the highest discounts for the buyer therefore minor party C should be rewarded as an encouragement to continue trading. Alternatively, the ranking could be derived from totally different criteria such as an assessment of demographic fit. Although minor party B may be trading aggressively and prepared to offer higher discounts, minor party C could be seen as a preferred supplier given that their publications for example may be considered more appropriate to the actual product being advertised.

In the embodiment shown, the representations in the major graphical user interface do not include the illuminateable regions although in an alternative embodiment these regions could be included. Generally, the illumineatable regions are to encourage the minor parties to trade. The major party relies to a greater extent on the rankings such that, for example, major party C may be seen as a preferred partners with minor parties A and B effectively providing fallback positions.

The major party interface also includes a package table 710 having done item column 711, a status column 712, a minor party column 713 and the price column 714. Thus, the items are identified in column 711 in a way substantially similar to their identification is column 611. Column 712 identifies the current status for each item. Thus, an offer has been made with respect to item 1 but this has been rejected. Item 4 has been sold to minor party A for a price P3. Item 5 has been sold to minor party B for a price P11, item 6 has been sold to minor party C for a price P12 and item & has been sold to minor party C for a price P113.

An offer has been made with respect to item 2 resulting in the status entry being identified has “respond”. This requires the major party to make a response to the effect that the offer has been rejected or accepted. In this example, the word “respond” is underlined and as such represents a link. Thus, it is possible for the major party to select this link resulting in a further interface being displayed from which a selection may be made as to whether the offer is accepted or rejected.

The major party package table 710 includes a column for each of the minor parties A, B and C representing offers that have been made by these minor parties. Thus, item 2 as received one offer of price P2 from minor party A, whereas item 3 as received a first offer of price P22 from minor party B, and a second offer of price P115 from minor party C.

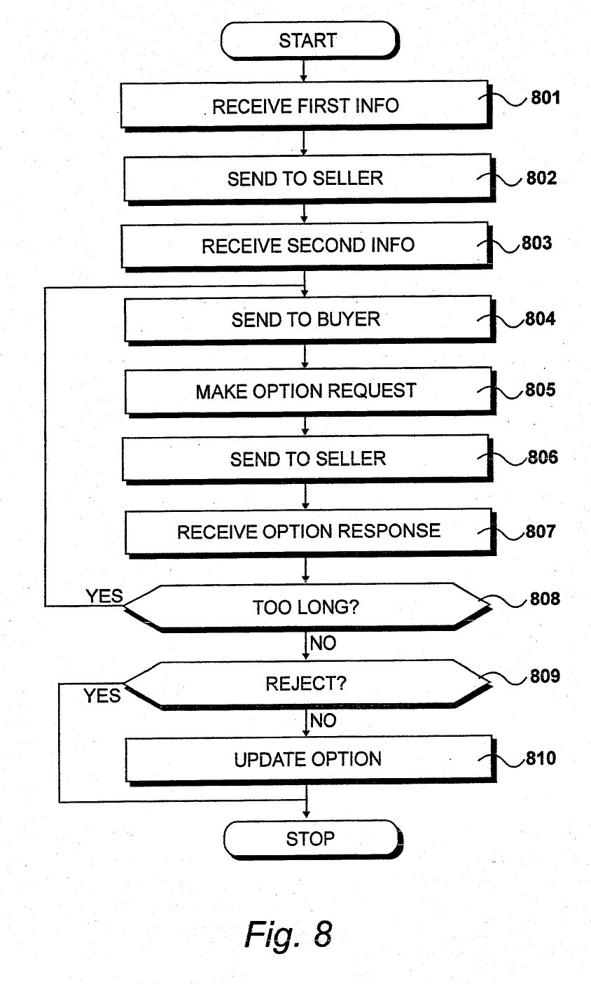

### FIG. 8

The embodiment described with reference to FIGS. 1 to 7 assumes that a major party exists who is in a position to encourage competition between a plurality of minor parties. In some negotiations, such an approach may be fruitful but in other situations a negotiation may become more sophisticated and conventionally this would include much one-to-one discussion by telephone.

The present applicant seeks to provide technical resources for facilitating sophisticated communications, so that such negotiations may be maintained while being conducted within a more efficient environment.

In an alternative embodiment, server 101 is configured to facilitate communications between buyers and sellers, such as between party 105 and party 103. In this embodiment, it is possible for a buyer to request an option such that a buyer has not committed to buying a particular item or package but, for a specified period, the seller agrees not to sell to any other buyer. In practice, the provision of options may be made without a specific charge, in order to encourage deals being made within the environment. Alternatively, a charge may be made for the option.

Procedures performed by server 101 for this alternative embodiment are illustrated in FIG. 8. At step 801, first information is received from a buyer usually identifying a particular item and a price that the buyer would be prepared to pay. At step 802, this first information is sent to the seller and at step 803 second information is received from the seller. This second information is sent to the buyer at step 804 and in response to receiving this information the buyer specifies a request for an option. Consequently, the option request is received at step 805.

At step 806, the request for an option information is sent to the seller resulting in an option response being received at step 807. The nature of the option response may consist of a rejection, to the effect that the seller is not prepared to give an option. Alternatively, the seller may grant the option. An intermediate position also exists to the effect that the seller is prepared to grant an option but the option period is considered to be to long. This means that should the buyer not take up the option, it would be difficult for the seller to sell the item within the time remaining.

Thus, at step 808 a question is asked as to whether the option period is too long and, if too long, this information is sent back to the buyer and further option requests may be submitted at step 805. If the period of option length is not an issue, the question asked at step 808 is answered in the negative.

At step 809, a question is asked as to whether the option is to be rejected and if answered in the affirmative the process returns back to the beginning. Alternatively, if the option is accepted and is not considered to be too long, the option is created and a table of options is updated at step 810.

If a question asked at step 808 is answered in the affirmative, to the effect that the option period is considered to be to long, it is possible for fifth information to be received from the buyer that specifies an alternative option period. The fifth information is sent to the seller and sixth information is received from the seller stating that the option has been accepted, rejected or that the option period is still to long. Thus, many iterations of this type could be performed until an option period as been agreed upon.

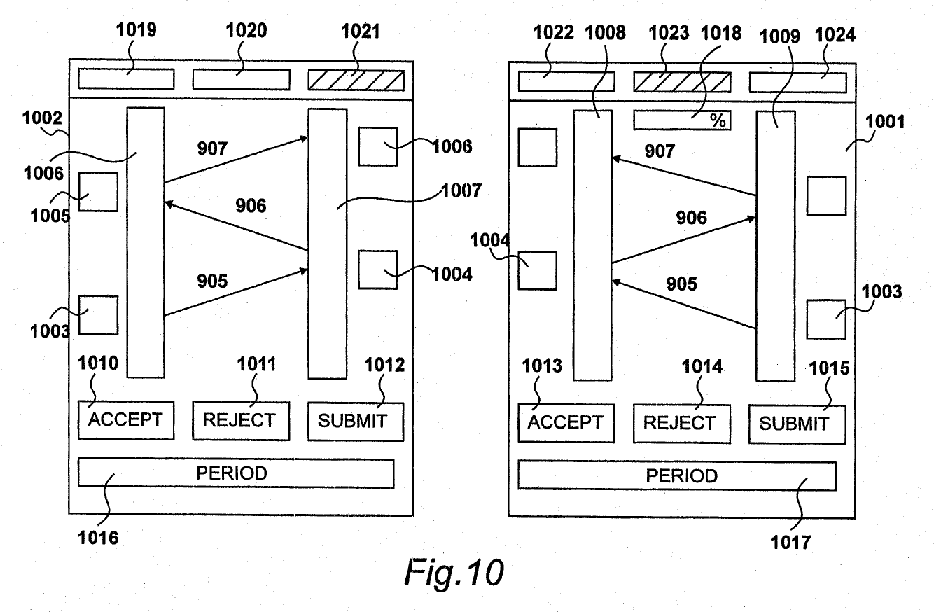

In an alternative embodiment, in which the fourth information states that the option period is too long, further steps are performed to the effect that fifth information is received from the buyer inviting the seller to enter an alternative negotiation environment. Fifth information is sent to the seller and an alternative negotiation environment is invoked. Further details of an example of an alternative negotiation environment will be described with reference to FIGS. 10 to 16.

In a further embodiment, a history is maintained of previous option transactions with each of a plurality of buyers. From this, a take-up rate is calculated for each of the buyers and preferably a take-up rate for a buyer is sent to a seller, so the seller is made aware of take-up rate averages for particular buyers. Thus, in a preferred embodiment, when a seller is communicating with a buyer who has requested an option, it is possible for the seller to be provided with this average take-up rate for the particular buyer concerned so that from this the seller may make a judgement as to whether it is likely that the option will be taken up.

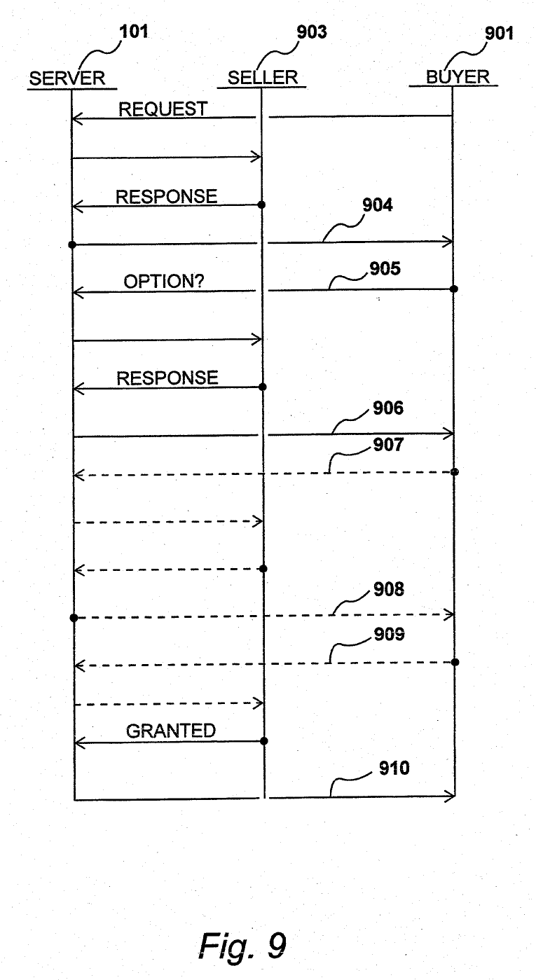

### FIG. 9

A protocol diagram for operations performed within the environment of FIG. 1 in accordance with an alternative embodiment is illustrated in FIG. 9. A buyer 901 issues a information 902 to a seller 903 identifying a selection from the inventory. The inventory represents time critical items such as advertising opportunities which of course have gone as soon as a publication say goes to press. Similarly, a radio advertisement is also time critical but other examples of time critical inventory are possible, such as hotel bookings, flight bookings and theatre tickets etc.

The seller 903 returns information 904 to the requesting buyer identifying the price and execution date for the selection. The buyer 901 returns information 905 to the seller 903 defining an option request that specifies an option period during which the selection could not be sold elsewhere. In response to receiving the option request 905, the seller 903 provides information to the effect that the option has been accepted, that the option has been rejected or that the option period is to long. Thus, further communications may take place, illustrated by dotted lines 907, 908 and 909. Eventually, in this example, agreement is reached and information 910 is issued from the seller 903 to the buyer to the effect that the option has been granted.

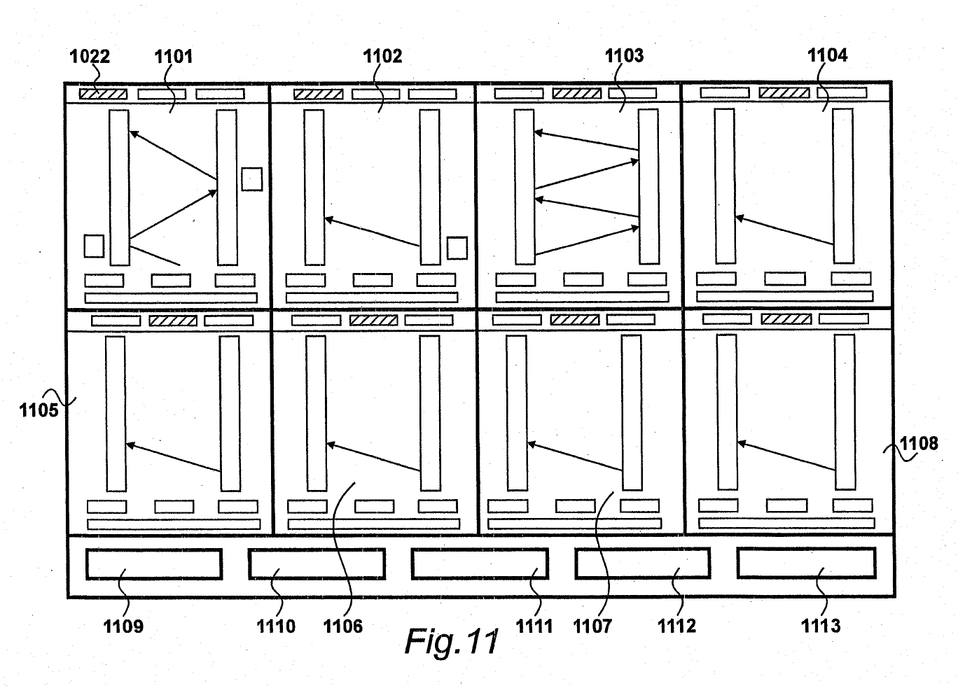

In one embodiment, when the server receives input data to the effect that the option period is to long, the server issues information to the parties inviting further negotiations. Thus, in a preferred embodiment, a first stage allows an option to be requested and granted in a relatively straightforward way. However, if negotiations are required, a new stage may be entered in order to facilitate ongoing negotiations which interactively provides graphical user interfaces at both the seller and the buyer as detailed with respect to FIG. 10 and 11.

From the example shown above, the new graphical interface facilitates ongoing negotiation directed towards agreeing the duration of the option period. However, it should be appreciated that the presence of these graphical user interfaces for negotiation purposes may be deployed for negotiating other aspects of the contract to supply inventory and in particular time-critical inventory. Thus, negotiations could take place with respect to price, a range of prices, a range of inventory or any other special feature relating to the nature of the advertisement. For example, this could include a requirement to the effect that the advertisement would only be placed if its positioning is consistent with editorial content.

Often negotiations will require several parameters to be considered at one time. Thus, for example, high levels of discount may be available for larger orders. A preferred embodiment of the present invention establishes graphical user interfaces which allow these negations to take place in an efficient manner thereby optimising the use of available manpower. In addition, a preferred aspect of the present invention allows a plurality of graphical user interfaces to be maintained simultaneously and displayed concurrently to a user. Thus, in this way, a user may maintain many negotiations simultaneously and attend to each, preferably in a prioritised order. Thus, manual intervention is only required when actual information is being conveyed and it is not necessary to maintain ongoing discussions or to hold communication channels open.

### FIG. 10

In the preferred embodiment, the agreed negotiation takes place in response to a first graphical user interface 1001 displayed to a selling operator and second graphical user interface 1002 being displayed to a buying operator. In the embodiment of FIG. 10, graphical user interface 1002 shows a first option period 1003 offered by the first party, that is to say the buying party. In response to this, the selling party establishers a first option period 1004 these option periods are connected by a first line 905.

An alternative second option period 1005 is established by the first party and again a second line 906 is shown connecting option period 1004 to option period 1005. In this example, proposed option period 1005 is submitted to the seller, as illustrated by line 907 and the seller then responds with a further option period illustrated at 1006.

In the graphical user interfaces, vertical bar 1006 identifies the buyer with a similar bar 1007 representing the seller. At the sellers station these positions are reversed such that the seller is identified by vertical bar 1008 and the buyer is identified by vertical bar 1009. Thus at each station, the user themselves is shown to the left with the other party being shown to the right. Thus, to a large extent, the seller graphical user interface 1001 is a mirror image of the buyer graphical user interface 1002.

The buying party enters data, such as an option period and this is shown to the right in graphical user interface 1001. Similarly, connecting line 905 is shown traversing from right to left in graphical user interface 1001, whereas it traverses from left to right in graphical user interface 1002.

Each graphical user interface includes buttons for accepting an offer, rejecting the offer or submitting an alternative offer. At the buyer graphical user interface 1002, these consist of an accept button 610, a reject button 611 and a submit button 612. Similarly, at the seller graphical user interface, there is an accept button 613, a reject button 614 and a submit button 615.

Negotiation is initiated by the buyer establishing an option period. To achieve this, numerical values are entered within box 1016, and a period box 1017 is provided at the seller interface 1001, thereby allowing the seller to enter alternative periods for submission.

The processors are initiated by offer data being entered within box 1016. In the embodiment shown, a single box 1016 is provided at the buyer graphical user interface with a single box 1017 being shown at the seller graphical user interface. In alternative embodiments, several boxes of this type could be provided, each responsive to a particular data type. Thus, for example, having specified the inventory of interest, it would be possible for negotiations to take place with respect to the price of the inventory as an alternative to option periods. Similarly, price and option durations could be considered together. Submit button 1012 is then selected, resulting in the transmission of this data to the seller. At interface 1001, information is shown at 1003 and in this example the seller identifies an alternative period at 1017 which is then submitted back to the buyer (via the server) by operational box 1015.

At any time, either party may close negotiations by the operation of the reject button 1011 or 1014. Operation of these buttons will result in a termination of the negotiation and the graphical user interfaces will close down.

Continuing with this specific example, option period 1004 is received at the browser and at this point line 906 is present but box 1005 is not. An alternative period is entered by the use of box 1016 and operation of submit button 1012, which at this point populates entry 1005 and transmits the offer period, as illustrated by line 907, to the seller, thereby populating box 1006. In its current state, an offer, represented by line 907, has been made from the buyer to the seller. At the buyer, line 907 points away, showing that the onus is on the other party to accept, reject or make a further submission. Similarly, at the seller graphical user interface, arrow 907 is shown pointing to the left, indicating that the onus is on the selling party.

In a preferred embodiment, the sellers browser is arranged to conduct many negotiations and over time negotiations will have taken place with many customers. In the advertising environment, each transaction may be considered as being part of an advertising campaign and as such it is possible for statistics to be maintained relating to that campaign.

During negotiations, the onus will be on one party or the other to make a decision, with the other party waiting for a response. Thus, each party may be considered as being in one of two states. In an active state, the party is expected to respond. In a passive state, the party is waiting for a response. As one party becomes passive the other party becomes active.

To emphasis the status of negotiations, each graphical user interface is provided with visual indicators. In a preferred embodiment, a first indicator 1019 displays red, a second indicator 1020 displays amber and a third indictor 1021 displays green at the buyers interface. Similarly, at the sellers interface a first indicator 1022 displays red, a second indicator 1023 displays amber and a third indicator 1024 displays green.

In this example, the hashed lines in indicator 1021 represent the green indicator being active; the interface being configured so only one of the indictors is active at any one time, displaying green, amber or red. Thus, a green glowing indicator 1021 shows that the buyers side is passive and is presently waiting for information from the sellers side.

To complement this, at the sellers side, amber indicator 1013 is shown active indicating that a response is required from the seller. As previously described, the system is preferably directed towards time-critical inventory therefore is time progresses the period during which an option may be granted become shorter and eventually no time remains and the deal may be lost. Thus, in a preferred embodiment, server 101 as reference to a real time clock and is aware of the execution date for each item of inventory. In this way, it is possible for the server to be aware as to when the critical date is approaching. Thus, if the critical date is approaching and the deal must be concluded quickly, the red indicator 1022 would be illuminated instead of the amber indicator 1023.

### FIG. 11

In a preferred embodiment, a display device at the server is configured to display a plurality of graphical user interfaces (each dedicated to a specific negotiation) as illustrated in FIG. 11. In the example of FIG. 7, each graphical user interface representing an active negotiation is shown as a tiled region on a visual display unit. Thus, the visual display consists of a total of eight active negotiation interfaces, 1101 to 1108. Furthermore, in addition to arranging each of the active interfaces so that they may be viewed, in a preferred embodiment the server is also configured to prioritise the arrangement of displayed graphical user interfaces.

In the example shown in FIG. 11, negotiations are ranked in terms of their urgency, with the most urgent placed in the top left corner and the least urgent in the bottom right corner. Thus, in this example, of all the active communications and negotiations, interface 1101 represents the most urgent and interface 1108 represents the least urgent.

In the example shown, the user interfaces 1101 and 1102 are very urgent and their red indicators 1022 are shown illuminated. The negotiation illustrated in FIG. 10 (with its amber indicator 1023 illuminated) is shown at 1103 and negotiations that have only recently commenced are shown at 1104 to 1108.

In a preferred embodiment, passive negotiations are minimised to an icon, as illustrated at 1109 to 1113. The passive negotiations (where the onus is presently upon another party to respond) remain minimised until a response has been received. Thereafter, they are included within the tiles, with appropriate reconfigurations taking place, and placed in a prioritised order.

The prioritising of the graphical user interface allows operator time to be optimised. In particular, an operator should be motivated to respond to negotiation interfaces positioned at the top left corner. Consequently, if an operator is in a position to respond within graphical user interface 1101 the state of this interface will change and the prioritised order of the interface will be rearranged. Thus, the negotiating party is continually dealing with the interface displayed in the top left corner. If a situation arises where it is not possible for the negotiating party to respond, possibly because said party requires additional information or supervision, the party would move on to the second highest prioritised interface, shown at 702. However, it can be appreciated that the majority of the prioritisation work has been done by the system, thereby substantially reducing the demands placed on the negotiating party and ultimately allowing negotiating parties to deal with substantially more negotiation positions simultaneously.

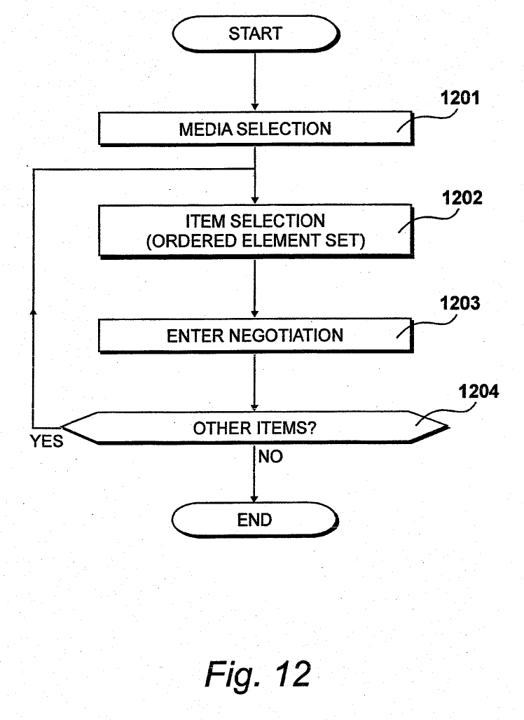

### FIG. 12

Procedures performed by a server processing unit in order to implement the embodiment described with reference to FIG. 11 illustrated in FIG. 12. Often, the items to be sold represent similar examples of an item that are mutually exchangeable and susceptible to being ranked in order of perceived value. Thus, in a preferred embodiment, the item is an advertisement of a particular size in a particular newspaper on a particular day and the elements represent similar opportunities to advertise within the same newspaper. Thus, each of these elements within the newspaper will include an allocated rate card price. However, it is usual for negotiations to occur in relation to this prices. Thereafter, in accordance with the present invention, it is possible for negotiations to be initiated with respect to the purchasing of an option. In this way, a complicated multi-dimensional experience is standardised into discreet stages which facilitate the totality of the experience and lead to enhanced economic efficiency.

Upon initiating a session, a client communicates with the network server and at step 1201 a media selection is made, possibly identifying a particular newspaper or a particular magazine.

At step 1202, item selection is made thereby identifying a particular example of inventory having a recorded price and an execution date. At step 1203 the negotiation process is performed, which may result in an acceptance or a rejection.

A question is asked at step 904 as to whether other items are to be considered and when answered in the affirmative further item selection takes place at step 1202.

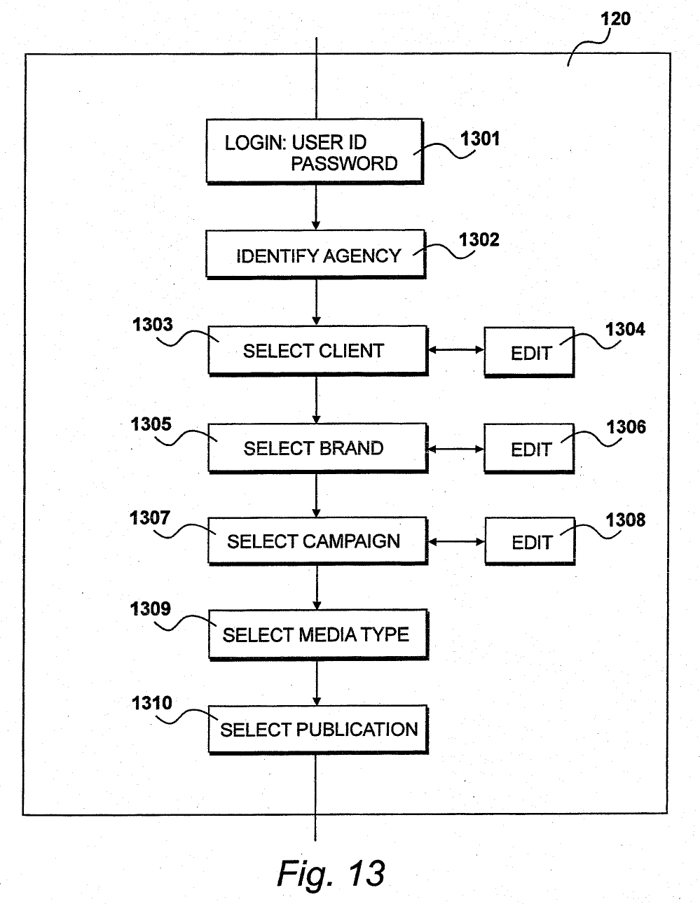

### FIG. 13

Procedures 1202 for media selection are detailed in FIG. 13. At step 1301 a user performs a login operation by identifying a user ID and a password. At step 1302 the user's agency is identified. At step 1303 the user identifies their particular client with an edit function 1304 being provided to allow the user to define new clients which may then be selected by means of a drop-down box.

At step 1305, a brand selection is made and again it is possible for new brands to be identified via an edit function 1306. Having selected a brand at step 1305, the particular campaign is identified at step 1307 and again it is possible for new campaigns to be specified via an edit function 1308. Thus, by providing this information it is possible for statistics to be developed relating to each individual campaign, each brand (which may involve several campaigns), each client (which may have several brands) and each individual agency which again may be dealing with several clients. Thus, statistics may be determined at the campaign level, brand level, client level or agency level.

In a preferred embodiment, a display representing the percentage of take-up, may be displayed at any of these levels, either by pre-configuration or by real time selection. Similarly, in an alternative embodiment, it would be possible for several figures to be displayed simultaneously.

At step 1309 a media type is selected, such as newspapers, magazines, television or radio etc. Furthermore, at this point, it may be possible for the server to check whether the user under consideration has been given authority to purchase advertising space for the particular media type of interest. Thus, some users may be restricted to say newspaper advertising while others may be restricted to radio advertising.

At step 1310, a particular publication of interest is selected. Thus, for example, having selected newspapers at step 1309 a particular newspaper may be selected at 1310.

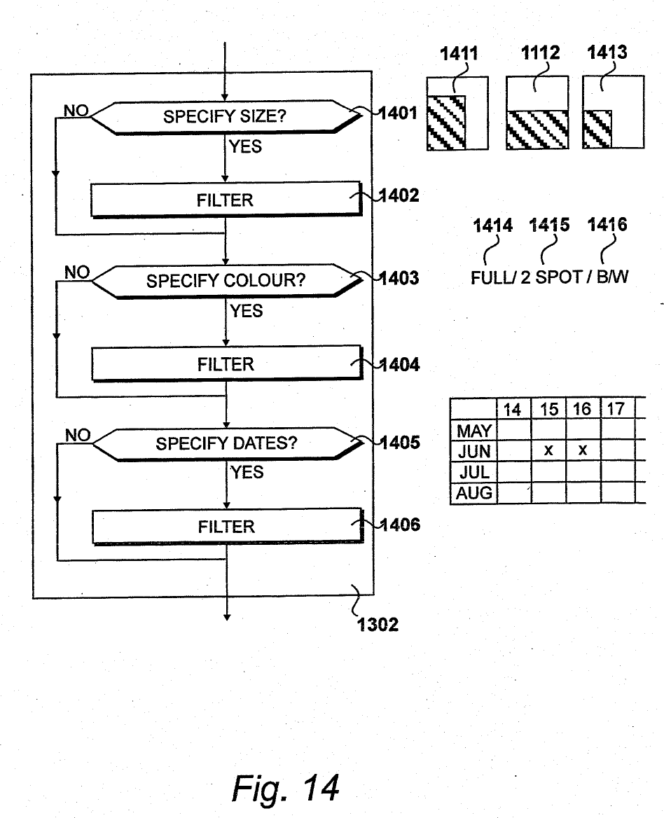

### FIG. 14

Procedures for specific item selection are detailed in FIG. 14. Having selected a particular publication at step 1310, it is likely that the user will wish to make a more refined selection. At step 1401, it is possible for a user to specify an advertisement size. For illustrative purposes, examples of advertisement size are shown, in which 1411 represents a three quarter page advertisement, 1412 represents a half page advertisement and 1413 represents a quarter page advertisement. Each of these advertisement sizes and positions a preferably identified by tags as defined by the inventory definitions in table 201. Thereafter, at step 1402, a filtering operation is performed to identify a subset of available inventory.

At step 1403 a question is asked as to whether colour is to be specified. In this example, it is possible to specify full colour 1414, two spot colours 1415 or black and white 1416. Again, having made a selection, a filtering operation of the inventory is performed at step 1404.

At step 1405 it is possible to specify dates and in the example shown a selection has been made to the effect that the client is interested in 15 and 16 June. Thus, having made this selection, a filtering operation is performed at step 1406.

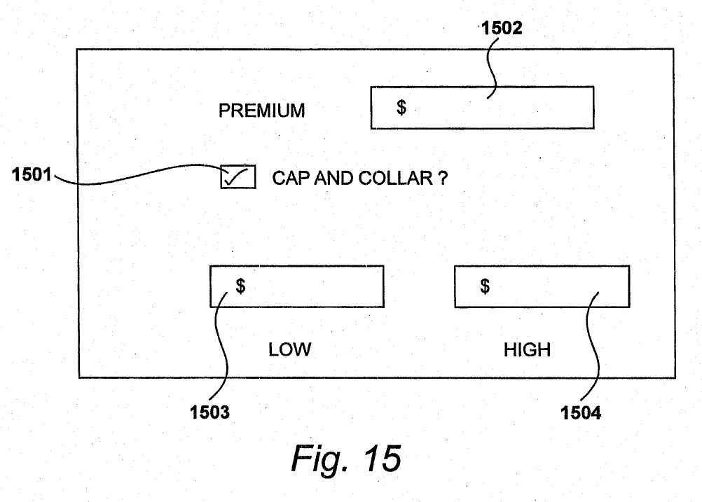

### FIG. 15

In a first alternative embodiment, the system is configured such that an option is either granted or rejected. However, in a more refined embodiment it is possible for more sophisticated options to be offered on the basis that a buyer will be required to pay a premium. Thus, in the enhanced embodiment, the option provides for the establishment of a contract to buy or sell a specific item of inventory which becomes the underlying interest. The contract then establishes a specific strike price at which the contract may be exercised or acted upon. The option has an expiration date which in the present preferred embodiment will be at a specified time before the execution date. Thus, when the option expires it no longer has a value and no longer exists.

There are two types of options which are generally referred to as calls and puts and it is possible to buy or sell either type.

When buying a call, the user has the right to buy the underlying instrument at the strike price on or before the expiration date. Alternatively, if the user buys a put, the user has the right to sell the underlying instrument on or before the expiration date. As the option holder, the user has the right to sell the option to another buyer during its term or to let it expire.

An alternative situation arises when the user is looking to write or sell the option. Under these circumstances, the user sells to create a short option position which then obliges the user (the writer) to fulfil their side of the contract if the holder wishes to exercise the option. When the user sells a call as an opening transaction, the user is obliged to sell the underlying interest at the strike price. When the user sells a put as an opening transaction, the user is obliged to buy the underlying interest. As a writer, the user has no control over whether or not a contract is exercised and the user needs to recognise that exercise is always possible at any time until the expiration date. Furthermore, just as the buyer can sell an option back into the market rather than exercising it, a writer can purchase an offsetting contract.

When an option is sold, the premium represents the amount received. The premium is not fixed and changes constantly so the premium paid today is likely to be lower or higher than the premium paid on other days. These changing prices reflect the give and take between what buyers are willing to pay and what sellers are willing to accept for the option.

In the present preferred embodiment, it is possible to apply the principles of option trading to media. This possibility arises by being able to definitively ascertain the value of the media. Mechanisms for achieving this include reference to the price achieved at the expiration date, the reach, that is to say the percentage of the target that is reached by the ad or the ad campaign and/or the frequency, that is to say the number of times the advertisement is seen.

It is unlikely that it would be possible to ascribe a price to the value of the ad on a second by second basis so value may be described by measuring value over a predefined time period. In this environment, an advertiser or their agency could purchase media space for large sums of money when relating to a major event. However, if that event under performs the advertising space could become worthless. Thus, an advertiser could use the optioning mechanism to offset the risk of an event under performing.

Furthermore, a “media broker” might study the risk associated with placing a particular advertisement and take a position without actually wanting the advertising itself. Thus, such an environment allows advertisers to mitigate risks and for brokers to profit by an acceptance risk.

A further preferred embodiment is illustrated in FIG. 12 which facilitates the establishment of a cap and collar. This is where a call and a put are combined so that the advertising value is artificially held within two limits. Effectively, it is as if an insurance premium has been paid to minimise the risk of poor performance of a campaign which is offset by selling an insurance premium for the advertising value exceeding a set value. Thus, if the advertising value of a sponsor is influenced by the bad performance of that sponsor the value goes down but if the performance of the sponsor is enhanced the advertising value goes up.

In the embodiment, the base price of the advertising or sponsorship is valued at a mid point. If there were no spread (ie profit for the broker) then this would give a net nil sum, in that the value of the brokers put would equate to the value of the performance change.

In the first alternative embodiment, having been granted an option a buyer is invited to cap and collar by ticking display box 1501. In response to ticking box 1501 a premium figure is displayed at 1502. In addition, a low value is displayed at 1503 and a high value is displayed at 1504. In a particular example of this option type, should the value of the advertisement fall below the low value 1503 a repurchase is guaranteed. However, if the value exceeds the high value 1504 the buyer is obliged to release the option such that the seller may obtain a higher price.

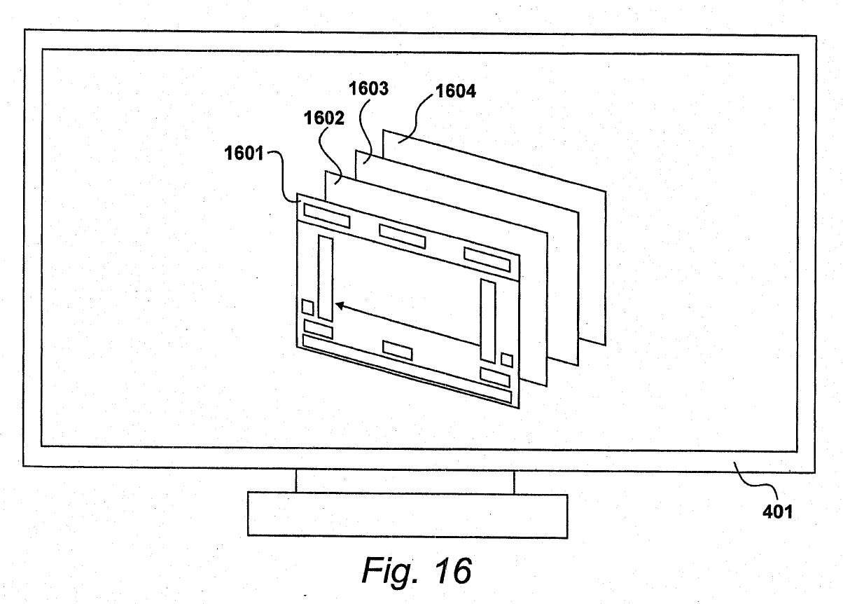

### FIG. 16

In an alternative arrangement to the second alternative embodiment, an alternative of graphical user interfaces is illustrated in FIG. 16. In this example, as an alternative to being tiled in a two-dimensional plane each individual graphical user interface is shown as a three-dimensional cascade, with the interfaces appearing to be placed one upon the other.

The system is configured to prioritise each graphical user interface such that the interface with the highest priority appears on top, in this example interface 1601. Thus, a user is clearly prompted to deal with the negotiation displayed within graphical user interface 1601 as a matter of urgency. Thus, having responded to this displayed negotiation, the arrangement of graphical user interfaces will be adjusted such that the next highest priority appears on top.

If for whatever reason it is not possible for a negotiating party to deal with a negotiation displayed within graphical user interface 1601, it is possible for other interfaces to be selected. Thus, positioning a mouse pointer in the region of interface 1602 and effecting a click results in this interface being placed at the top so that it is possible for negotiations to take place. Thereafter, the order of the interfaces will be adjusted in order to display the highest priority at the top.

Similarly, interface 1603 could be selected or interface 1604 could be selected.

What is claimed is:

1. A method of data processing, wherein processed data includes:
data representing negotiations for the purchasing of a package of inventory, taking the form of offers and counter-offers between a single major party comprising one of:
a buyer and
a seller and
a plurality of minor parties comprising one of:
sellers and buyers; and
data stored in a database representing details of items of the inventory available for sale, comprising the steps of:
identifying a package of inventory from said database;
presenting a major graphical user interface to a major party that shows data from each of a plurality of participating minor parties; and
presenting a minor graphical user interface to each of said minor parties that shows:
(a) a first indication of time remaining;
(b) a second indication of a proportion of said package of inventory remaining; and
(c) a representation of each participating minor party; wherein each said representation of a minor party includes:
(d) an indication as to whether the respective minor party has made an offer; and
(e) an indication as to whether said respective minor has made an offer that has been accepted.

2. The method of claim 1, wherein said inventory is an advertising media inventory.

3. The method of claim 2, wherein said advertising media inventory includes at least one of newspaper advertisements, magazine advertisements, posters, billboards, television commercials and radio commercials.

4. The method of claim 1, wherein each representation of a minor party includes:
(d) said indication as to whether the respective minor party has made an offer that has not been accepted;
(e) said indication as to whether said respective minor has made an offer that has been accepted; and
(f) an indication to the effect that the minor party has not made an offer.

5. The method of claim 1, wherein each said representation of said participating minor parties is configured to show said indications (d), (e) and (f) by changing at least one visual property.

6. The method of claim 1, wherein for the minor graphical user interfaces, each representation of said participating minor parties is configured to show said indications (d), (e) and (f) by changing the relative position of the representations of the minor parties.

7. The method of claim 1, wherein for the major graphical user interface, the relative position of the representations of the minor parties is changed to reflect the merit of previous transactions conducted with the respective minor party.

8. The method of claim 1, wherein for the major graphical user interface, the relative position of the representations of the minor parties is changed to reflect an appropriateness of dealing with particular minor parties.

9. The method of claim 1, wherein:
the major party is a major party buyer;
the minor parties are minor party sellers; and
said major party buyer displays a preferred inventory set to the minor party sellers via each said minor graphical user interface.

10. The method of claim 1, wherein:
the major party is a major party buyer;
the minor parties are minor party sellers; and
the major party buyer displays a maximum budget via each said minor graphical user interface.

11. The method of claim 1, wherein:
the major party is a major party seller;
the minor parties are minor party sellers; and
the major party seller displays an inventory set to the minor party buyers via each said minor graphical user interface.

12. A method of data processing in which said data represents negotiations for the purchasing of an item or items of time critical inventory, comprising the steps of:
storing data relating to details of a time critical inventory of items that have a sale price and an execution date in a database;
receiving first information from a buyer identifying an item of interest from said inventory;
sending said first information to a seller;
receiving a second information from said seller identifying a price and an execution date for said item of interest;
sending said second information to said buyer;
receiving a third information from said buyer that defines an option request that specifies an option period during which the item of interest could not be sold to another buyer;
sending said third information to the seller;
receiving fourth information from a seller browser stating that the option has been one of:
accepted,
rejected and
that the option period is too long; and
sending said fourth information to the buyer.

13. The method of claim 12, in which said fourth information states that the option period is too long, further comprising the steps of:
receiving fifth information from the buyer that specifies an alternative option period;
sending said fifth information to the seller; and
receiving sixth information from the seller stating that the option has been one of:
accepted,
rejected and
that the option period is still too long.

14. The method of claim 12, in which said fourth information states that the option period is too long, further comprising the steps of:
receiving fifth information from the buyer that invites the seller to enter an alternative negotiating environment;
sending said fifth information to the seller; and
invoking an alternative negotiating environment.

15. The method of claim 12, wherein a history is maintained of previous option transactions for each of a plurality of buyers and a take-up rate is calculated for each of said buyers.

16. The method of claim 15, wherein an indication of a buyer's take-up rate is sent to a seller.

17. A method of data processing in which said data represents negotiations for the purchasing of an item or items of inventory, comprising the steps of:
storing data relating to an inventory of items at a server;
receiving information from a buyer and a seller identifying at least one item from said inventory for which said buyer and said seller propose to enter into a negotiation;
supplying data to the buyer to establish a buyer graphical user interface; and
supplying data to the seller to establish a seller graphical user interface, wherein the buyer graphical user interface and the seller graphical user interface each display:
a local element representing a local party comprised of one of a:
buyer and
seller;
a remote element representing a remote party comprised of one of a:
seller and
buyer;
an indication of numerical offers made by the local party and the remote party; and
a graphical element showing the transmission of data between the buyer and the seller via the server so as to indicate an onus to respond.

18. The method of claim 16, wherein the seller graphical user interface and the buyer graphical user interface each have a graphical display to show one of:
that a negotiation is in a passive state,
that a negotiation is in an active state and
to show that a negotiation is in an active and urgent state.

19. The method of claim 16, wherein a plurality of graphical user interfaces are shown concurrently with each of said plurality of graphical user interfaces representing a specific negotiation.

20. The method of claim 19, wherein said plurality of graphical user interfaces are ranked according to their urgency of requiring a response.
